(19) United States
(12) Patent Application Publication
(10) Pub. No.: US 2012/0183699 A1
(43) Pub. Date: Jul. 19, 2012

(54) METHOD FOR FABRICATING FLEXIBLE BOARD USING SOLUTION PROCESS

(76) Inventors: Jin Jang, Seoul (KR); Min Hee Choi, Seoul (KR); Seung Hoon Han, Seoul (KR)

(21) Appl. No.: 13/498,473

(22) PCT Filed: Feb. 2, 2010
(86) PCT No.: PCT/KR10/00618

§ 371 Date: Mar. 27, 2012

(30) Foreign Application Priority Data
Sep. 29, 2009 (KR) 10-2009-0092577

(51) Int. Cl. B05D 1/36; B05D 7/00; B82Y 40/00

(52) U.S. Cl. 427/407.2; 427/407.1; 427/409; 977/847; 977/890

(57) ABSTRACT

Disclosed is a method for fabricating a flexible board using carbon nanotubes. The method includes applying a carbon nanotube-containing ink onto a substrate to form a deposited layer, and coating a polymeric or monomeric solution on the deposited carbon nanotube layer to form a thin film layer. In accordance with the method, the spin-coated carbon nanotube layer is coated with the polymeric or monomeric chemical solution to minimize an area where the base substrate contacts the polymeric film and thereby to advantageously form a flexible board readily separable from the substrate without applying any external stress or laser.

### TECHNICAL FIELD

The present invention relates to a method for fabricating a flexible board fixed on a silicon wafer or glass substrate.

### BACKGROUND ART

In order to use optimal fabrication equipment for conventional silicon wafers or glass substrates, a plastic board should be fixed on a hard substrate due to flexibility thereof.

There are largely three methods for fixing such a plastic board on a hard glass substrate.

Referring to FIG. 1, a method for fixing a plastic board on a glass substrate using a single-sided adhesive tape is suggested. A plastic film 2 is arranged on a glass substrate 1 and both ends thereof are fixed with a single-sided adhesive tape 3. This method is very simple and provides convenience in use, but has a disadvantage in that the plastic board is dented during high-temperature processes, since the glass substrate 1 does not adhere to the plastic board, and the glass substrate and the plastic board have different thermal expansion coefficients.

The method for fixing the glass substrate 1 and the plastic board 2 using a double-sided adhesive layer 4 is shown in FIG. 2. This method is advantageous in that adhesion between the glass substrate and the flexible board can be improved and the denting of plastic film caused by high-temperature processes can be avoided. However, this method has a disadvantage of difficult control over adhesive strength. That is, when the double-sided adhesive layer has strong adhesive strength, a high external stress is required to separate the plastic board from the substrate after completion of overall processes, and when it has weak adhesive strength, the substrate is disadvantageously separated therefrom during the process.

Referring to FIG. 3, in an attempt to solve the afore-mentioned problem, a sacrificial layer 5 is interposed between the glass substrate 1 and the plastic board 2 and is heated by laser irradiation after completion of the process to separate the film from the substrate. This method is advantageous in that adhesion between the glass substrate and the plastic board is improved and stress can be minimized when the plastic board is separated from the glass substrate. However, this method has disadvantages in that recycling of the sacrificial layer is not possible and fabrication costs are increased due to use of lasers.

As shown in FIG. 4, unlike the afore-mentioned process, a polymeric solution 6 is coated on the glass substrate 1 by a method such as spin coating to form a polymeric film, and the film is heated and solidified, and then removed. This method is also disadvantageous in that the polymeric film cannot be readily separated due to excessively high adhesive strength between the glass substrate and the polymeric film.

### DISCLOSURE OF INVENTION

### Technical Problem

Therefore, the present invention has been made in view of the above problems, and it is one object of the present invention to provide a method for fabricating a flexible board using carbon nanotubes wherein a spin-coated carbon nanotube layer is coated with a polymeric or monomeric chemical solution to minimize an area where a base substrate contacts a polymeric film and thereby to form a flexible board which can be readily separated from the substrate without applying any external stress or laser.

It is another object of the present invention to provide a method for fabricating a flexible board to realize the same effects as mentioned above by forming a deposited layer using a hydrophobic substance-containing ink as well as a carbon nanotube-containing ink.

### Technical Solution

In accordance with the present invention, the above and other objects can be accomplished by the provision of a method for fabricating a flexible board using carbon nanotubes, including spin-coating a carbon nanotube-containing ink on a substrate to form a deposited layer; and spin-coating a polymeric or monomeric solution on the deposited carbon nanotube to form a thin film layer.

In particular, the chemical solution that can be used for the afore-mentioned method may be selected from aromatic polyimide, polyphenylene sulfide and fluorine-based resins.

More specifically, the chemical solution may be polyimide (PI) or polymethyl-methacrylate (PMMA).

The substrate that can be used in the afore-mentioned fabrication process may be selected from glass, silicon wafer, stainless steel and sapphire substrates.

Alternatively, provided is a method for fabricating a flexible board by repeating the afore-mentioned fabrication process at least one time to form at least one composite film layer composed of a deposited layer and a thin film layer.

The fabrication process may use a hydrophobic substance-containing ink, instead of carbon nanotubes, to form a deposited layer. This fabrication process is realized in the same subsequent process as the process to realize the deposited layer using the carbon nanotube-containing ink layer.

In particular, when a hydrophobic substance is used, it is preferred that the hydrophobic substance be highly hydrophobic and have a contact angle of 80 degrees or higher.

### Advantageous Effects

The present invention provides a method for fabricating a flexible board that can be readily separated from a substrate without applying any external stress or laser by coating a spin-coated carbon nanotube layer with a polymeric or monomeric chemical solution in order to minimize an area where a base substrate contacts a polymeric film.

### BRIEF DESCRIPTION OF DRAWINGS

The above and other objects, features and other advantages of the present invention will be more clearly understood from the following detailed description taken in conjunction with the accompanying drawings, in which:

FIGS. 1 to 4 are sectional views illustrating a method for fabricating a board according to the prior art; and

FIGS. 5 to 7 are sectional views illustrating a method for fabricating a board according to the present invention.

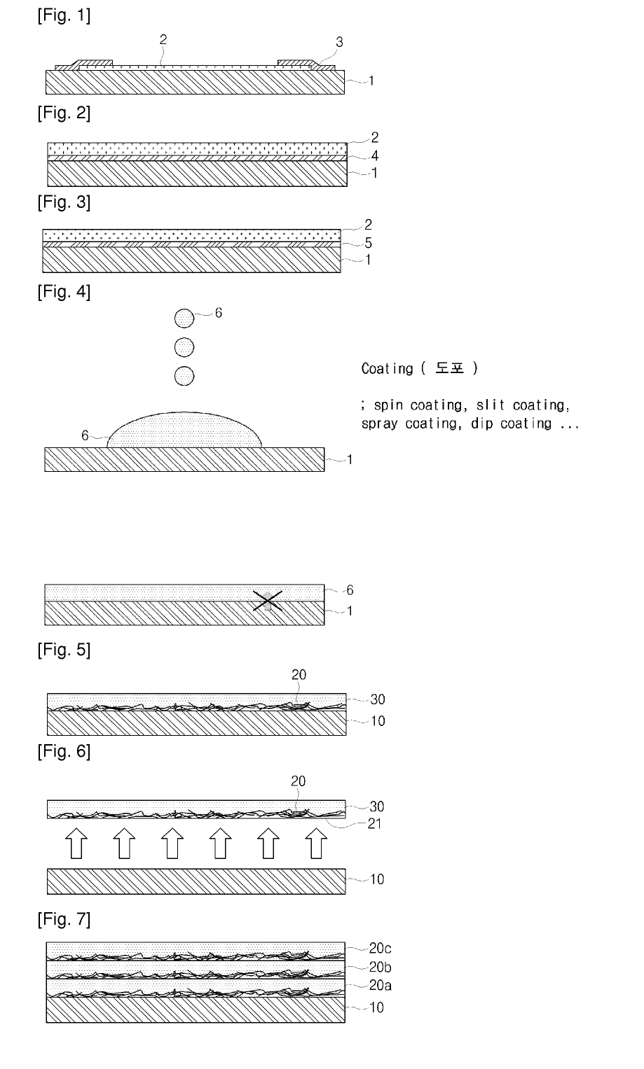

### BEST MODE FOR CARRYING OUT THE INVENTION

Hereinafter, configurations and operations of the present invention will be described with reference to the annexed drawings in detail below.

Referring to FIGS. 5 and 6, the method for fabricating a flexible board according to the present invention comprises applying a carbon nanotube 21-containing ink onto a substrate 10 to form a deposited layer 20; and spin-coating a polymer- or monomer-containing chemical solution on the deposited carbon nanotube layer to form a thin film layer 30. Various coating methods such as spin-coating, slit-coating, spray coating or dip-coating may be applied to the present invention.

The flexible board formed by the method can efficiently reduce an area where the thin film as a thin film layer contacts the glass substrate due to the chemical solution permeated between spin-coated carbon nanotubes, thus realizing the advantageous separation of the thin film layer from the glass substrate.

Of chemical solutions used for the afore-mentioned fabrication process, polymeric solutions may be selected from organic substances such as polyimide (PI), polymethyl-methacrylate (PMMA) and combinations thereof, which are deposited in the form of a fluid and solidified to obtain a thin film. In addition, the polymeric solution may be a mixture of the organic substance and a small amount of inorganic substance. Specifically, the polymeric solution may be selected from aromatic polyimide, polyphenylene sulfide and fluorine-based resins and combinations thereof. Alternatively, the polymeric solution may be aromatic polyimide obtained by condensation of pyromellitic dianhydride or diphenyl tetracarbonic anhydride, and aromatic polyimide such as diaminodiphenyl ether. The term polyimide (PI) resin used herein refers to a highly heat-resistant resin prepared by condensation-polymerizing aromatic tetra-carboxylic acid or derivatives thereof, and aromatic diisocyanate or derivatives thereof, followed by imidizing. The polyimide (PI) resin may have various molecular structures depending on the type of monomer used, and thus may exhibit various physical properties. Generally, aromatic tetracarboxylic acid used to prepare the polyimide (PI) resin may be pyromellitic dianhydride (PMDA) or diphenyl tetracarbonic anhydride (BPDA), etc., and aromatic diamine may be oxydianiline (ODA) or p-phenylenediamine (p-PDA).

Furthermore, monomeric solutions useful for the present invention may be epoxy-based compounds or UV-curable monomers and may be polymerized by thermal treatment or UV irradiation.

In addition, the substrates that can be used for the fabrication process may be made of a hard material, useful for semiconductor processes, selected from glass, silicon wafer, stainless steel and sapphire.

Referring to FIG. 7, the fabrication process may comprise repeating a series of steps comprising forming a deposited layer using a carbon nanotube-containing ink and forming a thin film layer using a polymer- or monomer-containing solution at least one time, to form a flexible board having a multi-layer structure including a plurality of carbon nanotube-comprising thin film layers 20a, 20b and 20c, and thereby realize a high-strength flexible board that has high strength due to the carbon nanotubes and can be readily separated from the glass substrate.

Hereinafter, another embodiment will be described. The fabrication process may use a hydrophobic substance-containing ink, instead of carbon nanotubes, to realize the deposited layer. This fabrication process is realized in the same subsequent process as the process to realize the deposited layer using the carbon nanotube-containing ink layer. In this case, it is preferred that the hydrophobic substance be highly hydrophobic and have a contact angle of 80 to 130 degrees. For example, the hydrophobic substance may contain a hydroxyl, amino or carboxylic group.

As mentioned above, the fabrication process according to the present invention enables formation of a flexible board which can be readily separated from a substrate without applying any external stress or laser by minimizing an area where the substrate contacts the thin film.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for fabricating a flexible board using carbon nanotubes, comprising:
applying a carbon nanotube-containing ink onto a substrate to form a deposited layer; and
coating a polymeric or monomeric solution on the deposited carbon nanotube layer to form a thin film layer.

2. The method according to claim 1, wherein the chemical solution is selected form aromatic polyimide, polyphenylene sulfide and fluorine-based resins.

3. The method according to claim 1, wherein the chemical solution is polyimide (PI) or polymethylmethacrylate (PMMA).

4. The method according to claim 1, wherein the substrate is selected from glass, silicon wafer, stainless steel and sapphire.

5. The method according to claim 4, wherein the formation processes of the deposited layer and the thin film layer are repeated at least one time, to form at least one composite film layer composed of the deposited layer and the thin film layer constituting the flexible board.

6. A method for fabricating a flexible board, comprising:
applying an ink containing a highly hydrophobic substance with a contact angle higher than 80 degrees onto a substrate to form a deposited layer; and
coating a polymer- or monomer-containing chemical solution on the deposited hydrophobic substance to form a thin film layer.

7. The method according to claim 6, wherein the hydrophobic substance has a contact angle of 80 to 130 degrees.

8. The method according to claim 7, wherein the hydrophobic substance contains a hydroxyl, amino or carboxylic group, or a combination thereof

9. The method according to claim 7, wherein the chemical solution is selected form aromatic polyimide, polyphenylene sulfide and fluorine-based resins.

10. The method according to claim 7, wherein the chemical solution is polyimide (PI) or polymethylmethacrylate (PMMA).

11. The method according to claim 7, wherein the substrate is selected from glass, silicon wafer, stainless steel and sapphire.

12. The method according to claim 11, wherein the formation processes of the deposited layer and the thin film layer are repeated at least one time, to form at least one composite film layer composed of the deposited layer and the thin film layer constituting the flexible board.
